(19) United States
(12) Patent Application Publication
(10) Pub. No.: US 2009/0180502 A1
(43) Pub. Date: Jul. 16, 2009

(54) Injection Locking Type Light Source Which of The Noise Can be Minimized

(75) Inventors: Jae-Oh Byun, Cheonan-si (KR); Ji-Min Seo, Seoul (KR)

Correspondence Address: OLIFF & BERRIDGE, PLC, P.O. BOX 320850, ALEXANDRIA, VA, 22320-4850, US

(73) Assignee: LUXPERT TECHNOLOGIES CO., LTD., BUK-GU (KR)

(21) Appl. No.: 12/227,631

(22) PCT Filed: May 29, 2007
(86) PCT No.: PCT/KR2007/002578

§ 371 Date: Nov. 24, 2008

(30) Foreign Application Priority Data
May 30, 2006 (KR) 10-2006-0048752

(51) Int. Cl. H01S 3/13; H01S 3/00

(52) U.S. Cl. 372/32; 359/344

(57) ABSTRACT

An injection seed of an injection locking type light source includes a broadband light source, a seed circulator receiving and transmitting a light from the light source to a seed optical filter passing only a desired wavelength band among the light beams from the light source and passing through the seed circulator, and an injection light source receiving a light beam of a specific wavelength band passing through the seed optical filter and outputting the wavelength-locked light beam without modulation to the seed optical filter at a predetermined power. The seed optical filter receives and outputs the wavelength-locked light beam from the injection light source to the seed circulator, and the seed circulator receives and outputs the wavelength-locked light beam as a seed beam. Since noise signal of a seed beam is small, noise signal of a final transmitting beam is also small and preferable for the high speed communication.

### TECHNICAL FIELD

The present invention relates to a light source for wavelength division multiplexing optical communication, and more particularly, to an injection locking type light source capable of minimizing noise for a high speed communication at Giga degree.

### BACKGROUND ART

In order to effectively satisfy the suddenly increasing demands for communication, a wavelength division multiplexing optical transmitter is rapidly and widely used. In this wavelength division multiplexing optical transmission equipment, since respective channels to connect a transmitter to a receiver are distinguished by wavelengths of an optical signal, a light source used in the transmitter must have a stable output wavelength and interference with adjacent channels must be minimized.

FIG. 1 is a view illustrating a conventional injection locking type light source used as a light source in a transmitter. Referring to FIG. 1, a broadband light source 10 is used to generate a seed beam 10a and the seed beam 10a is inputted into a TX circulator 20. The seed beam 10a inputted into the TX circulator 20 is transmitted to a TX optical filter 30 and the TX optical filter 30 filters the seed beam 10a by wavelength bands λ 1 to λ n and passes the filtered seed beam 10a by the N number of channels. A TX light source 40 receives a beam 30a passing through the TX optical filter 30 and outputs wavelength locked beam 30b. The TX optical filter 30 receives the wavelength locked beam 30b outputted from the TX light source 40 and outputs the same to the TX circulator 30, and the TX circulator 30 receives the outputted wavelength locked beam 30b and outputs the same as a transmission beam 21.

The seed beam 10a is not filtered yet so has a wide range wavelength spectrum 12. However, the beam 30a passing through the TX optical filter 30 and inputted into the TX light source 40 has specific wavelength bands with respect to every channels in view of the wavelength spectrum 32a, and has a relative intensity noise (RIN) as much as W1 in view of oscilloscope waveform 34a.

A Fabry-perot laser diode (FP LD) or a reflective semiconductor optical amplifier (RSOA) may be used as the TX light source 40. FIG. 2 is a graph illustrating a gain curve of the laser diode or the semiconductor optical amplifier. As illustrated in FIG. 2, an output noise is less than an input noise due to saturation characteristic of the laser diode or the semiconductor optical amplifier.

When the RSOA is used as the TX light source 40 and is directly modulated by current intensity to turn on (level 1 (one))/off (level 0 (zero)), a magnitude of noise W2 at the level 1 (turned on state) is less than W1 due to the saturation characteristic of the laser illustrated in FIG. 2 in view of wavelength spectrum 32b and oscilloscope waveform 34b of the wavelength locked beam 30b. However, since the reduction degree is not sufficient, there is a limit to increase the number of channels as illustrated in FIG. 3 so that there is a restriction to be used in the high speed communication. Even in a case of using the FP LD as the TX light source 40, similar wavelength spectrum 32b′ is obtained.

FIG. 3 is a view illustrating noise characteristic according to the number of channels, wherein FIG. 3A illustrates wavelength spectrum 32b and oscilloscope waveform 34b of the wavelength locked beam when the number of channels is 32 and FIG. 3B illustrates wavelength spectrum 32b and oscilloscope waveform 34b of the wavelength locked beam when the number of channels is 16.

As bandwidths t2 and t2′ are increased, noise components W2 and W2′ of frequency are decreased. In other words, W2′ when the wavelength bandwidth t2′ is 0.8 nm, is less than W2 when the wavelength bandwidth t2 is 0.4 nm. Thus, since the wavelength bandwidths t2 and t2′ must be increased in order to reduce the noise components, in the case FIG. 3B rather than FIG. 3A, in other words, the 16 channels are more preferable than the 32 channels. Thus, according to the related art, the number of channels must be reduced and an optical filter AWG must be exchanged with a new one in order to reduce the noise components for the high speed transmission.

Moreover, the above-mentioned conventional injection locking type light source has the following disadvantages.

1. When a transmitting speed is increased, a magnitude of an optical power influencing a receiving unit must be increased according to the transmission rate (reception sensibility must be increased), and this means the increase of the optical power of the transmitting unit. To this end, generally only current of a light source of the transmitting unit is increased as much as possible under a maximum threshold. However, in a case of using the conventional injection locking type light source, an output of the broadband light source 10 to generate the seed beam must be also increased. In this case, it is very difficult to increase the output of the broadband light source 10. Although an optical amplifier is installed to increase the output, since the wavelength spectrum 12 of the broadband light source 10 is very wide, every not-used wavelength band is also amplified so that the efficiency is inferior.

2. When a light beam outputted from the broadband light source 10 is divided by wavelengths by the optical filter 30 and enters the TX light source 40, the noise characteristic of the incident light beam 30a is very poor due to physical characteristic of the broadband light source 10. When the TX light source 40 is modulated by the wavelength locking method using the signal, the output signal of the wavelength locked light beam 30b has a poor noise characteristic as described above.

These noise characteristics appear over most frequency bands and the receiver electrically filters the signal with an optical band (generally, 60% to 70% of transmitted frequency) according to transmission rate to remove the noise components without distortion of the signal so that a clean receiving signal can be obtained and the noise characteristics do not matter in a low speed (100 Mbps level) system. However, since band to be filters becomes wide (about greater than 10 times) in a high speed (higher than 1 Gbps) system, the filtering of the noise components is as less than that so that the transmission quality is influenced. In order to solve this problem, the bandwidth of the wavelength division is increased to decrease the noise components of the injection light source as illustrated in FIG. 3. However, in this case, the number of channels to be used by the system is decreased so that costs of the system must be increased.

Moreover, in a case when the bandwidth of the wavelength division becomes wide, the wavelength band of the transmitted signal also becomes wide so that the reachable transmission distance by chromatic dispersion is decreased in inverse proportion to it. The limit of the transmission distance due to the chromatic dispersion significantly matters at the transmission rate, especially at the Giga bps transmission rate. This problem cannot be solved by the optimization or the improvement of specification of a using device and has a physical limit in view of structure. Particularly, the conventional injection locking type light source cannot be applied in the transmission distance at transmission rate (2.5 Gbps or 10 Gbps) higher than the above-mentioned transmission rate.

### DISCLOSURE

### Technical Problem

Therefore, the present invention has been made in view of the above and/or other problems, and it is an object of the present invention to provide a injection locking type light source suitable to be used in a high speed transmission by minimizing a noise signal by enabling a control of the noise signal according to required specification to be used.

### Technical Solution

In order to achieve the above objects, there is provided an injection locking type light source comprising: a TX transmitting unit to receive a seed beam through an injection seed and to output a wavelength-locked light beam as a transmitting light beam; the injection seed including: a broadband light source; a seed circulator to receive a light beam emitted from the broadband light source and to transmit the same to a seed optical filter; the seed optical filter to pass only a desired wavelength band among the light beams emitted from the broadband light source and passing through the seed circulator; and an injection light source to receive a light beam of a specific wavelength band passing through the seed optical filter and to output the wavelength-locked light beam without modulation to the seed optical filter at a predetermined power; and wherein the seed optical filter receives the wavelength-locked light beam outputted from the injection light source and outputs the same to the seed circulator, and the seed circulator receives the wavelength-locked light beam and outputs the wavelength-locked light beam as a seed beam.

Here, the TX transmitting unit comprises: a TX circulator to receive the seed beam and to transmit the same to the TX optical filter; the TX optical filter to pass a desired wavelength band among the seed beams inputted from the TX circulator; and a TX light source to receive a light beam of a specific wavelength band passing through the TX optical filter, to output a wavelength-locked light beam to the TX optical filter, and to directly modulate optical power to be outputted at this time.

In this case, the TX optical filter receives the wavelength-locked light beam outputted from the TX light source and outputs the same to the TX circulator; and the TX circulator receives the wavelength-locked light beam and outputs the wavelength-locked light beam as a transmitting light beam.

The injection locking type light source further comprises a sub-seed identical to the injection seed and installed between the injection seed and the TX transmitting unit to receive an output light beam emitted from the seed circulator of the injection seed and to output a wavelength-locked light beam. In this case, the TX transmitting unit receives-the light beam outputted from a circulator of the sub-seed as a seed beam.

The injection locking type light source further comprises a vice-sub-seed identical to the sub-seed and installed between the sub-seed and the TX transmitting unit to receive an output light beam emitted from a circulator of the sub-seed and to output a wavelength-locked light beam. In this case, the TX transmitting unit receives the light beam outputted from a circulator of the vice-sub-seed as a seed beam.

The injection light source of the injection seed comprises a Fabry-perot laser diode (FP LD) or a reflective semiconductor optical amplifier (RSOA).

The TX light source comprises a Fabry-perot laser diode (FP LD) or a reflective semiconductor optical amplifier (RSOA).

### Advantageous Effects

As described above, according to the present invention, since the noise signal of the optical power of the seed beam 110a provided to the TX transmitting unit is smaller than the conventional case, the noise signal of the transmitting beam 21 finally outputted from the TX transmitting unit is also smaller. Thus, it is preferable in the high speed communication.

### DESCRIPTION OF DRAWINGS

FIG. 1 is a view illustrating a conventional injection locking type light source used as a light source in a transmitter;

FIG. 2 is a graph illustrating a gain curve of a laser diode;

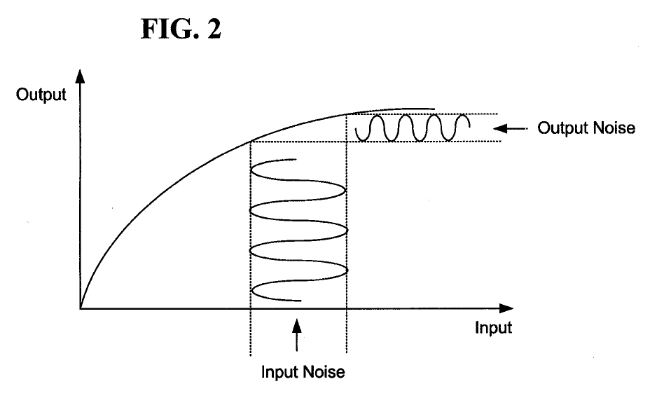

FIG. 3 is a view illustrating noise characteristic according to the number of channels;

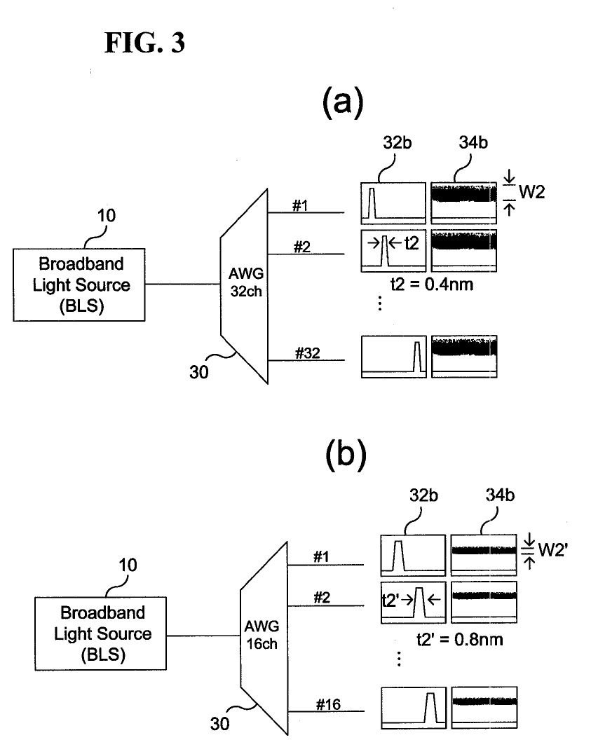

FIG. 4 is a view illustrating an injection locking type light source according to a first embodiment of the present invention;

FIG. 5 is a view illustrating an injection locking type light source according to a second embodiment of the present invention; and

FIG. 6 is a view illustrating an injection locking type light source according to a third embodiment of the present invention.

### BEST MODEL

Hereinafter, a preferred embodiment of the present invention will be described in detail with reference to the attached drawings. The following description is presented to enable one skilled in the art to make and use the invention, and is provided in the context of particular applications and their requirements. Thus, the following description of embodiments consistent with the present invention provides illustration and description, but is not intended to be exhaustive or to limit the present invention to the precise form disclosed. Various modifications to the disclosed embodiments will be apparent to those skilled in the art, and the general principles set forth below may be applied to other embodiments and applications. Thus, the present invention is not intended to be limited to the embodiments shown and the inventors regard their invention as any patentable subject matter described.

### EMBODIMENT 1

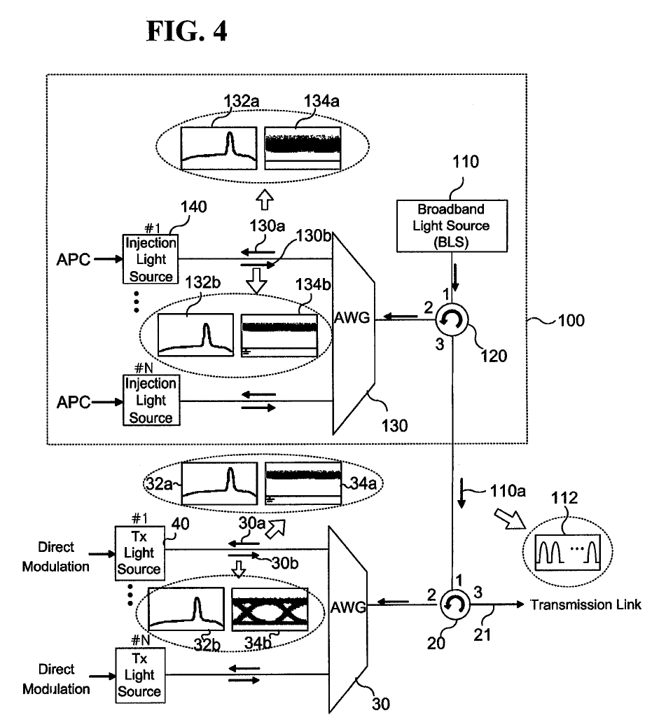

FIG. 4 is a view illustrating an injection locking type light source according to a first embodiment of the present invention. The injection locking type light source according to the first embodiment of the present invention includes an injection seed 100 and a TX transmitting unit. The TX transmitting unit receives a seed beam 110a through the injection seed 100 and outputs a wavelength locked light beam outputted from a TX light source 40 as a transmission light beam 21.

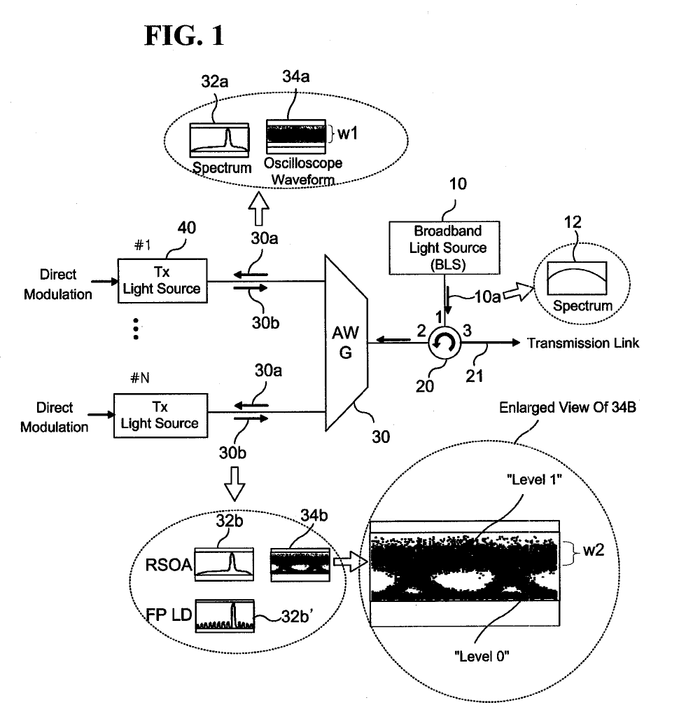

The TX transmitting unit, like in FIG. 1, includes a TX circulator 20 to receive the seed beam 110a and to transmit the same to a TX optical filter 30, a TX optical filter 30 to pass only a desired wavelength band of the seed beams inputted from the TX circulator 20, and a TX light source 40 to receive a light beam of a specific wavelength band passing through the TX optical filter 30, to output a wavelength locked light beam 30b to the TX optical filter 30, and to directly modulate an optical power to be outputted. The TX optical filter 30 receives the wavelength locked light beam 30b outputted from the TX light source 40 and outputs the received wavelength locked light beam 30b to the TX circulator 20, and the TX circulator 20 receives the wavelength locked light beam 30b and outputs the same as a transmitting light beam 21.

A difference from FIG. 1 is that wavelength spectrum 112 of the seed beam 110a does not have the wide wavelength band like the wavelength spectrum 12 in FIG. 1 but has a narrow wavelength band by channels.

The injection seed 100 includes a broadband light source 110, a seed circulator 120 to receive a light beam from the broadband light source 110 and to transmit the same to a seed optical filter 130, the seed optical filter 130 to pass only a desired wavelength band among light beams passing through the seed circulator 120, and an injection light source 140 to receive a light beam of a specific wavelength band passing through the seed optical filter 130 and to output a wavelength locked light beam to the seed optical filter 130 by an automatic power control (APC).

The seed optical filter 130 receives the wavelength locked light beam outputted from the injection light source 140 and outputs the same to the seed circulator 120, and the seed circulator 120 receives the wavelength locked light beam and outputs the same as a seed beam 110a to the TX transmitting unit.

The seed beam 10a is a light beam wavelength-locked and gain-saturated by the broadband light source 110 and is filtered by the seed optical filter 130 so that the wavelength spectrum 112 has a narrow wavelength band by channels. As such, according to the related art, the light beam emitted from the broadband light source 10 having the wide wavelength band is inputted as a seed beam 10a into the TX circulator 20, a light beam with a narrow wavelength band by channels, in the present invention, is inputted as the seed beam 110a.

Moreover, in the injection seed 100, a wavelength-locked signal 130a of the broadband light source 110 has noise determined by a divisional band due to the physical characteristic. When the optical signal 130a is injected into the injection light source 140 and is wavelength-locked, the optical signal 130a can be adjusted to be operated in a gain saturation region by the automatic power control (APC) of a proper driving current. Thus, a reference number 134b having noise components less than a reference number 134a is outputted. Thus, the noise of the seed beam 110a is remarkably reduced in comparison to the case of using the broadband light source 10 to generate the seed beam 10a as illustrated in FIG. 1.

Therefore, under the condition that a light source and other optical devices having the noise components of the light beam 30a inputted into the TX light source 40 by the respective channels are used, when comparing oscilloscope waveform 34a in FIG. 4 with that in FIG. 1, the waveform 34a in FIG. 4 is smaller, and due to this, the oscilloscope waveform 34b in FIG. 4 of the noise components of the wavelength-locked beam 30b that is outputted from the TX light source 40 is smaller than that in FIG. 1.

As such, since the seed beam 110a, in comparison to the conventional case, is supplied to the TX transmitting unit at the improved state of the noise characteristic, an improved output can be obtained when the seed beam 110a is modulated in the TX light source 40 in comparison to the conventional case. It means that this result can be applied to a high speed system of Giga bps level without trouble.

### EMBODIMENT 2

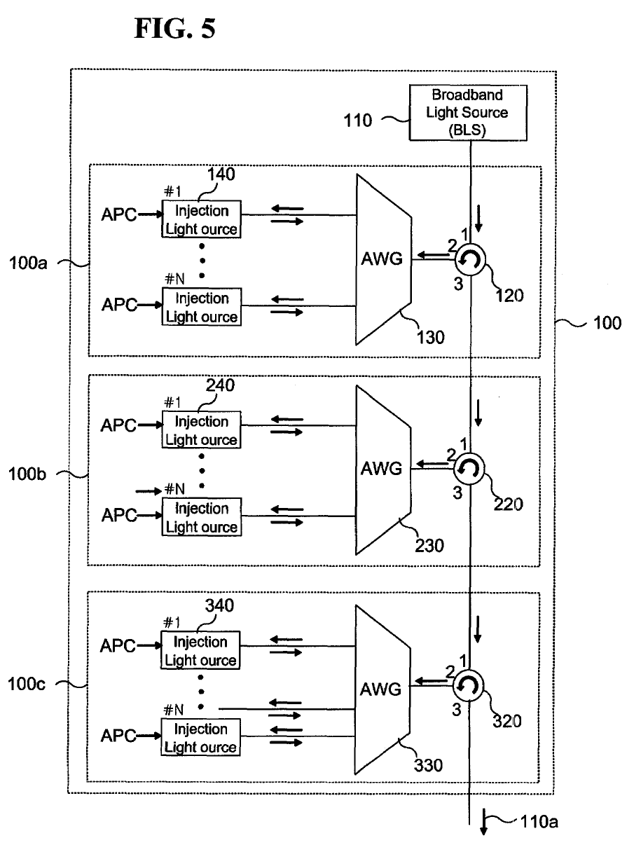

FIG. 5 is a view illustrating an injection locking type light source according to a second embodiment of the present invention. A difference from FIG. 4 is that the injection seed 100 includes a plurality of identical seed blocks 100a, 100b, and 100c. A first seed block 100a outputs an optical signal undergone the process as illustrated in FIG. 4, and a second seed block (sub-seed) 100b positioned lower than the first seed block 100a in series receives the output signal from the first seed block 100a as an input signal. A this seed block (vice-sub-seed) 100c receives the output signal from the second seed block 100b as an input signal and outputs the same as the seed beam 110a to the TX transmitting unit.

As such, undergone the multiple processes, noise components of a light beam outputted from the seed circulator 120 to adjacent seed circulators 220 and 320 are gradually decreased and the seed beam 110a suitable for the high speed communication can be obtained. Moreover, since the number of the processes of the seed blocks is adjusted to obtain a desired noise characteristic, the noise characteristic can be controlled according to a required specification for a system.

### EMBODIMENT 3

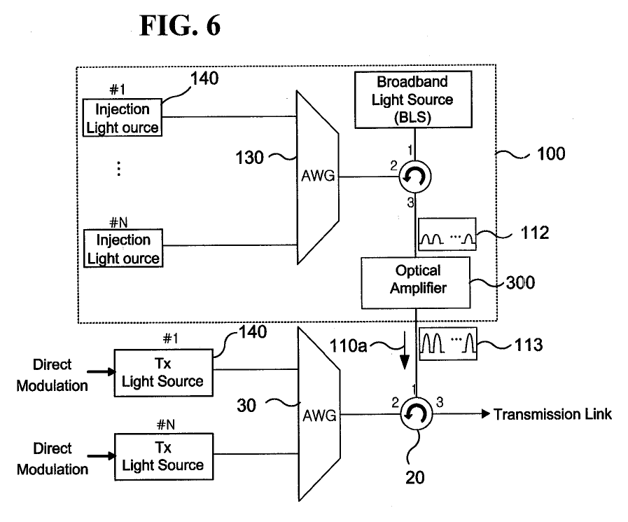

FIG. 6 is a view illustrating an injection locking type light source according to a third embodiment of the present invention. The seed beam 10a has respective wavelength components corresponding to wavelength division band of the TX optical filter 30 and the respective wavelength channels are provided to the TX circulator 20 in a state of reducing the noise characteristic. In this case, since the seed beam 110a provided to the TX transmitting unit can be amplified to a sufficient output by the optical amplifier, the above-mentioned problem can be solved by installing an optical amplifier 300 between the seed circulator 120 and the TX circulator 20 when a high output seed beam 110a is required.

However, in the conventional case as illustrated in FIG. 1, since the wavelength band of the wavelength spectrum 12 of the seed beam 10a is widely spread, every not-used wavelength is amplified when the seed beam 10a is amplified by the optical amplifier so that efficiency becomes inferior. Especially, in a case of long transmission distance, power loss to the subscriber equipment increases and due to this an optical line terminal must transmit a stronger seed beam in order to maintain the power of the seed beam to reach the transmitting unit of the subscriber equipment. In this case, a general optical amplifier is used to amplify only a using wavelength so that the seed beam can be effectively generated.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An injection locking type light source comprising:
a TX transmitting unit to receive a seed beam through an injection seed and to output a wavelength-locked light beam as a transmitting light beam;
the injection seed including:
a broadband light source;
a seed circulator to receive a light beam emitted from the broadband light source and to transmit the same to a seed optical filter;
the seed optical filter to pass only a desired wavelength band among the light beams emitted from the broadband light source and passing through the seed circulator; and
an injection light source to receive a light beam of a specific wavelength band passing through the seed optical filter and to output the wavelength-locked light beam without modulation to the seed optical filter at a predetermined power; and
wherein the seed optical filter receives the wavelength-locked light beam outputted from the injection light source and outputs the same to the seed circulator, and the seed circulator receives the wavelength-locked light beam and outputs the wavelength-locked light beam as a seed beam.

2. The injection locking type light source as set forth in claim 1, wherein the TX transmitting unit comprises:
a TX circulator to receive the seed beam and to transmit the same to the TX optical filter;
the TX optical filter to pass a desired wavelength band among the seed beams inputted from the TX circulator; and
a TX light source to receive. a light beam of a specific wavelength band passing through the TX optical filter, to output a wavelength-locked light beam to the TX optical filter, and to directly modulate optical power to be outputted at this time;
the TX optical filter receives the wavelength-locked light beam outputted from the TX light source and outputs the same to the TX circulator; and
the TX circulator receives the wavelength-locked light beam and outputs the wavelength-locked light beam as a transmitting light beam.

3. The injection locking type light source as set forth in claim 1, further comprising a sub-seed identical to the injection seed and installed between the injection seed and the TX transmitting unit to receive an output light beam emitted from the seed circulator of the injection seed and to output a wavelength-locked light beam, wherein
the TX transmitting unit receives the light beam outputted from a circulator of the sub-seed as a seed beam.

4. The injection locking type light source as set forth in claim 1, further comprising a vice-sub-seed identical to the sub-seed and installed between the sub-seed and the TX transmitting unit to receive an output light beam emitted from a circulator of the sub-seed and to output a wavelength-locked light beam, wherein
the TX transmitting unit receives the light beam outputted from a circulator of the vice-sub-seed as a seed beam.

5. The injection locking type light source as set forth in claim 1, wherein the injection light source of the injection seed comprises a Fabry-perot laser diode (FP LD) or a reflective semiconductor optical amplifier (RSOA).

6. The injection locking type light source as set forth in claim 1, wherein the TX light source comprises a Fabry-perot laser diode (FP LD) or a reflective semiconductor optical amplifier (RSOA).

7. The injection locking type light source as set forth in claim 1, further comprising an optical amplifier installed between the seed circulator of the injection seed and the TX transmitting unit.

8. The injection locking type light source as set forth in claim 3, further comprising an optical amplifier installed between the sub-seed and the TX transmitting unit.

9. The injection locking type light source as set forth in claim 4, further comprising an optical amplifier installed between the vice-sub-seed and the TX transmitting unit.
